(19) United States
(12) Patent Application Publication
(10) Pub. No.: US 2009/0307323 A1
(43) Pub. Date: Dec. 10, 2009

(54) APPARATUS AND METHOD FOR SUPPORTING SETTING OF DESTINATION OF EMAIL

(75) Inventors: Shingo Kato, Yamato-shi (JP); Masashi Miyazaki, Kawasaki-shi (JP); Hiroshige Ochimizu, Yamato-shi (JP); Masami Tada, Sagamihara-shi (JP)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/475,549

(22) Filed: May 31, 2009

(30) Foreign Application Priority Data
Jun. 4, 2008 (JP) 2008146639

(51) Int. Cl. G06F 15/82

(52) U.S. Cl. 709/206

(57) ABSTRACT

In a client 20, an operation accepting section 22 obtains a primary address entered in an address entry field, and a transmitting section 21 sends the primary address to a mail server 10. In the mail server 10, a receiving section 19 receives the primary address; a message generating section 13 generates a message including out-of-office information corresponding to the primary address; and a transmitting section 11 sends the message to the client 20. In the client 20, a receiving section 29 receives the message, and a display section 24 displays an out-of-office message that a user corresponding to the primary address is away, and thereafter displays detailed information including buttons for setting an alternative address according to a click operation on a specific portion. An address updating section 26a displays an alternative address in the address entry field according to a button click operation.

### CROSS-REFERENCE TO RELATED APPLICATIONS

This application claims priority under 35 U.S.C. §119(a) to Japanese Patent Application Serial Number 2008-146639, filed Jun. 4, 2008, entitled “APPARATUS AND METHOD FOR SUPPORTING SETTING OF DESTINATION OF EMAIL”, the entirety of which is incorporated herein by reference.

### BACKGROUND OF THE INVENTION

1. Field of the Invention

The present invention relates to electronic mail (email). In particular, the present invention relates to an apparatus and a method for supporting the setting of the destination of an email.

2. Description of the Related Art

In recent years, email has become a major communication method for organizations including companies. Email is not suitable for urgent business because it doesn't request real-time response unlike phone calls. However, when a user who received email cannot read it for a long period, the email sender cannot receive a reply for a period longer than that expected. This may interfere with work.

Thus, a technique is proposed to inform the sender of an email of the destination user of the email is away (for example, refer to Japanese Unexamined Patent Application Publication No. 9-134390.

Japanese Unexamined Patent Application Publication No. 9-134390 discloses a technique by which, when mail is sent, the server obtains the schedule of the recipient from the address input by the sender of the mail, and compares the time of reception and the times at which that user goes away and comes back in the schedule to extract necessary out-of-office information (the period, details, category of the out-of-office state, etc.), and informs the sender about it.

Techniques are also proposed to allow an alternative user to receive email when the destination user of the email is away (for example, refer to Japanese Unexamined Patent Application Publication No. 11-4251 and Japanese Unexamined Patent Application Publication No. 7-46270).

Japanese Unexamined Patent Application Publication No. 11-4251 discloses a technique by which, when a mail sender sends mail with a time limit to a user who is away, the mail is automatically transferred to another recipient according to an automatic transfer list that is determined by the recipient who is away, and when the other recipient provides a notification of the reception, the reception is reflected to the automatic transfer list so that the mail sender and the first recipient who is away can confirm the transfer. Japanese Unexamined Patent Application Publication No. 7-46270 discloses a technique by which the user registers two or more alternative recipients in advance to allow substitute recipients to receive only items categorized as “authorized substitute reception”.

A known technique for preventing email from being vainly sent due to a delay in reading is a technique of, if the destination user of a mail loaded is a substitute incoming-mail manager, generating incoming mail information for informing the substitute incoming-mail manager, and when the substitute incoming-mail manager accesses, informing the user of corresponding incoming mail information (for example, refer to Japanese Unexamined Patent Application Publication No. 6-62045).

Other known techniques for simplifying the setting of an email destination include: a technique for converting an address containing a specific keyword, if present in the address of received email, to an actual address and distributing it (for example, refer to Japanese Unexamined Patent Application Publication No. 10-173697); and a technique for extracting a keyword from the subject of mail to manage the mail addresses of destination according to the frequency of use, both for reception and transmission per unit time, such as date, week, and month, and the mail addresses of destination that cannot be supported only by the frequency of use per unit time (only one or two times a year but every year without exception) (for example, refer to Japanese Unexamined Patent Application Publication No. 2002-197027).

As disclosed in the foregoing unexamined Japanese patent application publications, various techniques have been proposed for taking measures when an email destination user cannot read email for a fixed period.

However, the technique of Japanese Unexamined Patent Application Publication No. 9-134390 does not allow the sender of an email to be informed that the email destination user is away until the email is sent. The technique of Japanese Unexamined Patent Application Publication No. 11-4251 also does not allow the sender of an email to be informed of the transfer of the email to an alternative user until the email is sent. The techniques of Japanese Unexamined Patent Application Publication No. 7-46270 and Japanese Unexamined Patent Application Publication No. 6-62045 have no idea of informing the sender of an email that the email was transferred to an alternative user or that an alternative user is informed of the incoming email.

If the sender of an email is informed that the destination user of the email cannot read email for a fixed period before the email is sent, the sender of the email can stop sending the email, or alternately, continue sending the email to a substitute, such as a manager, a secretary, or a project leader. The techniques disclosed in such Patent Documents, however, have the problem of a delay in processing because the sender can take an action only after being informed that the destination user cannot read email for a fixed period after the email is sent.

Although Japanese Unexamined Patent Application Publication No. 10-173697 and Japanese Unexamined Patent Application Publication No. 2002-197027 simplify the setting of the destination of an email, they provide no destination setting means when the destination user of an email cannot read email for a fixed period.

### BRIEF SUMMARY OF THE INVENTION

According to an embodiment of the present invention, there is provided an apparatus that supports the setting of the destination of an email. The apparatus includes a detecting section that detects a destination address of an email as a primary address in response to a user's input; and a display section that displays a message before sending the mail when receiving status information, from a recipient of the mail, indicating that the mail is not read by the recipient for a predetermined period.

In this case, the display section may display a message including a specific object and may display information on a specified period according to a user operation performed on the specific object.

When an alternative address substituting for the primary address has been registered in addition to the status information, the display section may further display the alternative address. In this case, when the alternative address has been registered in association with a specific category, the display section may display the alternative address information that further indicates that the alternative address is substituting for the primary address for email in the specific category. The display section may further display an entry field for the destination address of the email. When a user operation on an object corresponding to the entry field and the alternative address is performed, the display section may display the entry field, with the alternative address entered.

The display section may further display an entry field for the destination address of the email. When a user operation on an object corresponding to the primary address is performed, the display section may display the entry field, with the primary address entered in the entry field being deleted.

The apparatus may further include a receiving section that receives a second email from another apparatus. The apparatus may be configured such that the detecting section detects the destination address of the second email received by the receiving section; and when a second recipient of the second email has set status information indicating that the second mail is not read for a specified period, the display section notifies the another apparatus of the status.

According to the present invention, there is provided an apparatus that supports the setting of the destination of an email. The apparatus includes a detecting section that detects the destination address of the email as a primary address according to an operation of a user for entering the destination address; a determining section that determines whether the primary address detected by the detecting section has status information and an alternative address substituting for the primary address, the status information indicating that the email is not read for a specified period; and a display section that displays an entry field for the destination address of the email, and when the determining section determines that the status information and the alternative address have been registered, the display section displays alternative address information including the information of the alternative address and an object corresponding to the entry field and the alternative address, wherein when a user operation on the object is performed, the display section displays the entry field, with the alternative address entered.

According to the present invention, there is provided a method for supporting the setting of the destination of an email. The method includes the steps of detecting the destination address of the email as a primary address according to an operation of a user for entering the destination address; and when the primary address detected by the detecting section has status information indicating the status of the email, displaying a message indicating that the email is not read for a specified period.

According to the invention, there is provided a program product for a computer that supports the setting of the destination of an email. The program product includes computer usable program code for detecting the destination address of the email as a primary address according to an operation of a user for entering the destination address; and computer usable program code for displaying, when the primary address detected by the detecting section has status information indicating the status of the email, a message indicating that the email is not read for a specified period.

### BRIEF DESCRIPTION OF THE SEVERAL VIEWS OF THE DRAWINGS

FIG. 1 is a general view of a computer system according to an embodiment of the present invention.

FIG. 2 is a diagram showing a display screen example for use in entering out-of-office information according to the embodiment of the present invention.

FIG. 3 is a diagram showing a display screen example in which an out-of-office message is displayed according to the embodiment of the present invention.

FIG. 4 is a diagram showing a first display screen example in which detailed information is displayed according to the embodiment of the present invention.

FIG. 5 is a diagram showing a display screen example in which a destination address is reset according to the embodiment of the present invention.

FIG. 6 is a diagram showing a second display screen example in which detailed information is displayed according to the embodiment of the present invention.

FIG. 7 is a diagram showing a display screen example in which incoming mail is opened according to the embodiment of the present invention.

FIG. 8 is a block diagram showing an example of the functional configuration of a mail server and a client according to the embodiment of the present invention.

FIG. 9 is a flowchart of an example of the operation of the mail server and the client when an out-of-office message is displayed according to the embodiment of the present invention.

FIG. 10 is a flowchart of an example of the operation of the client when detailed information is displayed according to the embodiment of the present invention.

FIG. 11 is a flowchart of an example of the operation of the client when a destination address is reset in a first operation example before the transmission of an email according to the embodiment of the present invention.

FIG. 12 is a flowchart of an example of the operation of the client when a destination address is reset in the first operation example before the transmission of an email according to the embodiment of the present invention.

FIG. 13 is a flowchart of an example of the operation of the client when a destination address is reset in the first operation example before the transmission of an email according to the embodiment of the present invention.

FIG. 14 is a flowchart of an example of the operation of the client when a destination address is reset in a second operation example before the transmission of an email according to the embodiment of the present invention.

FIG. 15 is a diagram showing an example of the hardware configuration of a computer incorporating the embodiment of the present invention.

### DETAILED DESCRIPTION OF THE INVENTION

A best mode for carrying out the present invention (hereinafter, referred to as an embodiment) will be described in detail with reference to the drawings.

First, a computer system incorporating the embodiment will be described.

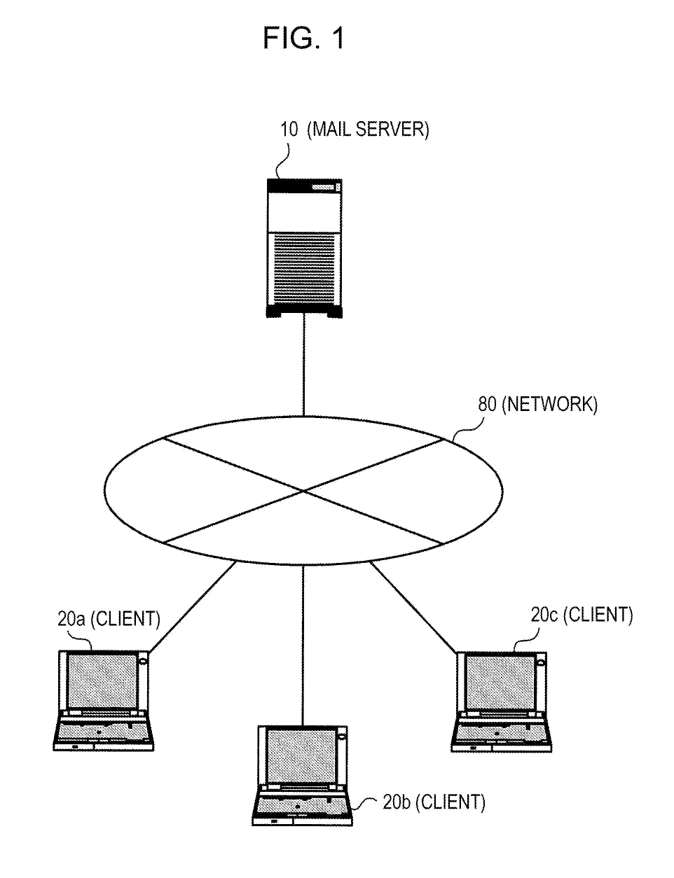

FIG. 1 is a general view of such a computer system.

As illustrated, this computer system includes a mail server 10, a client 20a, a client 20b, and a client 20c connected together through a network 80.

The mail server 10 is a server computer that transmits and receives email. Strictly speaking, examples of the server computer include an SMTP server that sends an email to a user in another network and a POP sever that stores email sent to a user in its own network to respond to a reception request from a user. Here, they are all referred to as the mail server 10 without distinction. In this embodiment, the mail server 10 stores mail addresses (hereinafter, referred to as alternative addresses) that are used as the destinations of an email as substitutes for the respective mail addresses of users when the users are out of their offices, and sends alternative addresses in response to inquiries from users who are going to send email.

The clients 20a, 20b, and 20c are terminal devices, such as PCs, for users. More specifically, the clients 20a, 20b, and 20c are terminal devices that are used to reset and send an alternative address when the user of a destination address set in an email is away and to receive the email. For example, the client 20a stores an alternative address in the mail server 10, the client 20b sends an inquiry to the mail server 10 about whether the destination user of an email is out of the office, and if the user is out of the office, the client 20b resets an alternative address and sends the email to the client 20c. The client 20c receives the email sent by the client 20b for user reading. While FIG. 1 shows only three clients, more than three clients may be provided. When there is no distinction among the clients 20a, 20b, and 20c, they are simply referred to as “client 20”.

The network 80 is communication means for use in exchanging messages. Examples of the network 80 are the Internet and a local area network (LAN).

In this computer system of this embodiment, when a user enters the mail address (destination address) of the destination user of an email into an address entry field when composing the email, the status of the user is displayed. When the status shows that contact with the user cannot be made because of a long vacation or the like, the information of an alternative address substituting as the destination address is displayed in the message of the mail. The destination address of the email is reset using the information of the alternative address.

Secondly, the outline of this operation will be described.

First, we will describe the outline of an operation for entering information that a user is away (hereinafter, referred to as out-of-office information) into the mail server 10 before the user becomes unable to read email for a specified period, like being away due to a long vacation or the like.

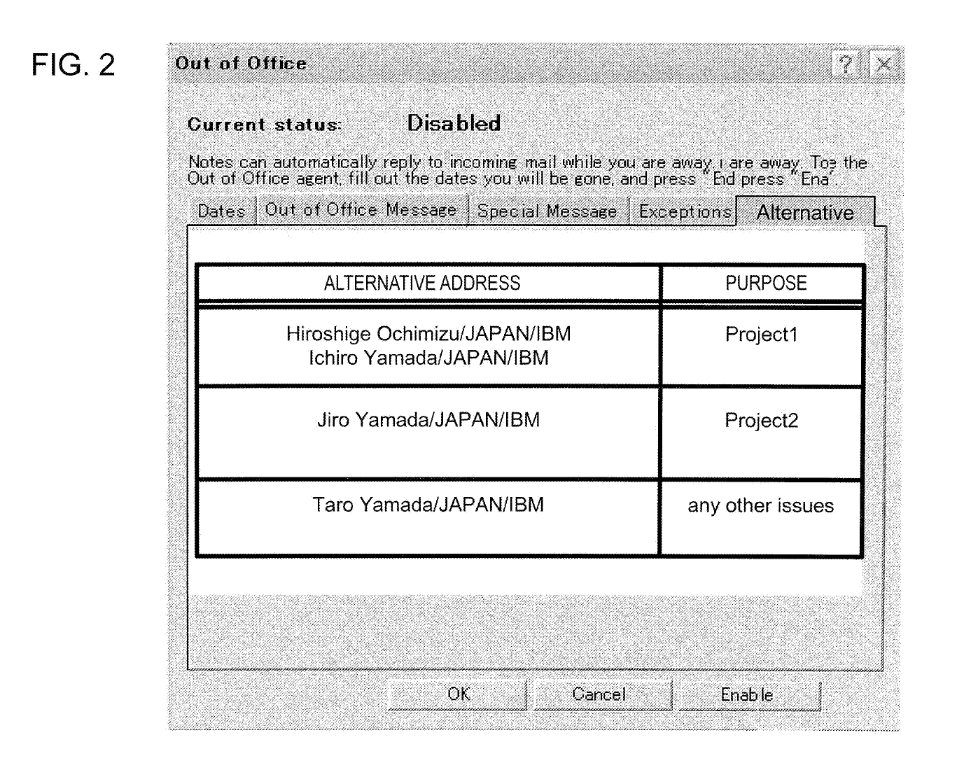

FIG. 2 shows a display screen example for use in entering the out-of-office information of a user.

This display screen example includes a plurality of tabs. For example, the leftmost “Dates” tab is used for designating the period during which the user is away-*.

In this embodiment, the rightmost “Alternative” tab is used to designate an alternative address. For each alternative address, its purpose, which is an example of the categories of an email, is defined. In other words, the purposes the alternative addresses of the email are defined. FIG. 2 shows that “Hiroshige Ochimizu/JAPAN/IBM” and “Ichiro Yamada/JAPAN/IBM” are alternative addresses of an email sent for “Project1”, and “Jiro Yamada/JAPAN/IBM” is an alternative address of an email sent for “Project2”. “Taro Yamada/JAPAN/IBM” is an alternative address of an email for any other issues. For example, the mail addresses of the manager and the secretary of the user may be stored as such alternative addresses. The mail addresses of the manager and the secretary may automatically be obtained in connection with a system of managing the mail addresses of company staffers.

FIG. 2 shows that the current status is “Disabled”, that is, the out-of-office notifying function is out of operation. Clicking on “Enable” button enables the out-of-office notifying function to change the current status to “Enabled”.

The following is the outline of an operation of the sender of an email for entering a destination address into the address entry field on the screen of the client 20, wherein when a user corresponding to the destination address is away, to set an alternative address.

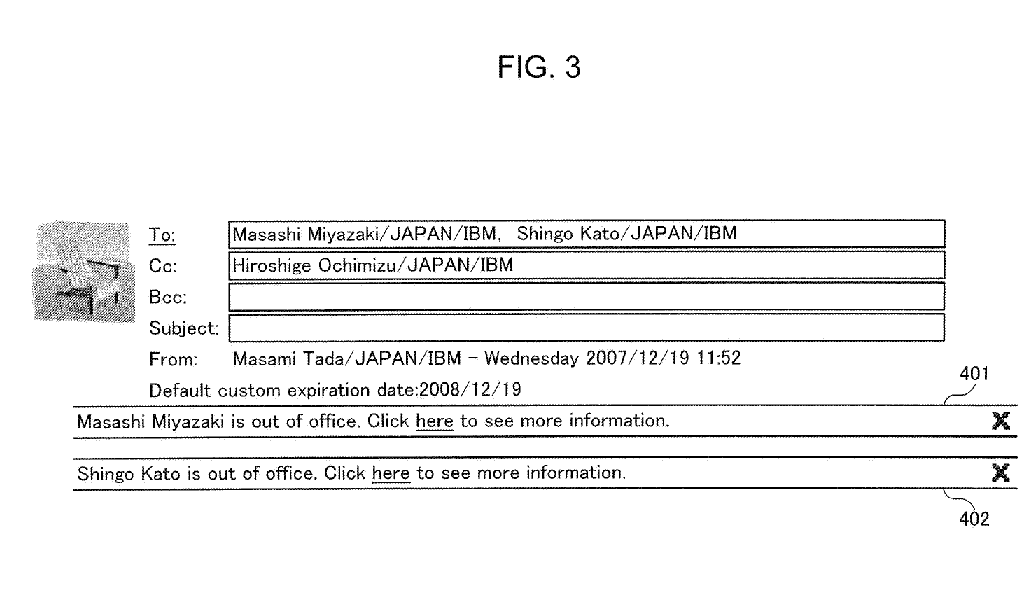

FIG. 3 shows a display screen example when the sender of an email first enters destination addresses. Hereinafter, the destination addresses first entered are each referred to as “a primary address”.

When the user corresponding to the primary address that is entered in the address entry field is away, the display screen displays information that the user is away (hereinafter, referred to as “an out-of-office message”.

FIG. 3 shows an out-of-office message 401 that “Masashi Miyazaki/JAPAN/IBM” is away and an out-of-office message 402 that “Shingo Kato/JAPAN/IBM” is away because “Masashi Miyazaki/JAPAN/IBM” and “Shingo Kato/JAPAN/IBM” are out of the office. The out-of-office messages 401 and 402 include a description that “Click here to see more information.” indicative of an operating method for obtaining more detailed information.

When the user clicks a mouse button on “here”, which is an example of specific objects in this description, more detailed information (hereinafter, referred to as “detailed information”) is displayed.

This embodiment proposes two methods for the operation from the display of this detailed information to the setting of an alternative address. The methods will be described in sequence.

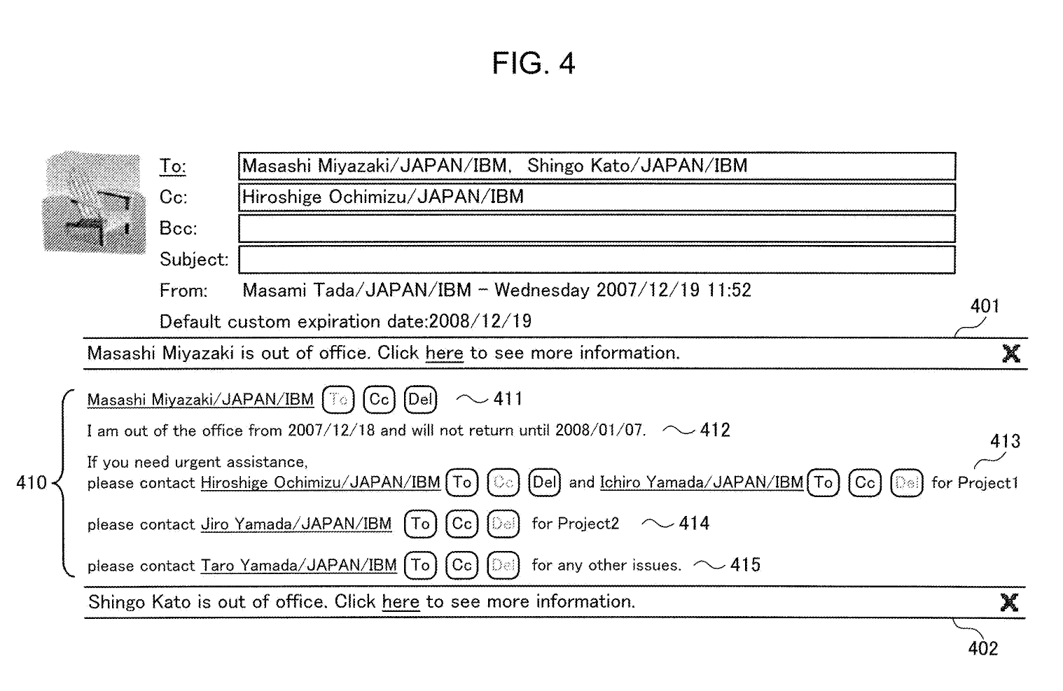

FIG. 4 shows a first display screen example in which detailed information is displayed.

FIG. 4 shows detailed information 410 of “Masashi Miyazaki/JAPAN/IBM” after a user clicks “here” in the out-of-office message 401. The detailed information 410 includes primary-address information 411 for setting or deleting the primary address, period information 412 indicative of the out of office period, and alternative address information 413 to 415 for setting or deleting alternative addresses. The primary-address information 411 and the alternative address information 413 to 415 include buttons (“To” button, “Cc” button, and “Del” button, which are examples of objects. “To” button is a button for inputting a corresponding mail address to a To-address entry field (hereinafter, referred to as “To-address entry field”. “Cc” button is a button for inputting a corresponding mail address to a Cc-address entry field (hereinafter, referred to as “Cc-address entry field”. “Del” button is a button for deleting a mail address that has already been entered in the To-address entry field or the Cc-address entry field.

When there is no need to include the detailed information 410 in the message of the email, “x” on the right of the out-of-office message 401 can be clicked on to make it invisible.

The out-of-office message 401 is displayed by the number of users who set out-of-office information among the destination users of an email. In the case where there are many such users, so that all the out-of-office messages 401 cannot be displayed on the screen when the detailed information 410 is displayed, only part of the out-of-office messages 401 may be displayed at the same time.

Thereafter, the sender of the email resets a destination address with reference to the alternative address information.

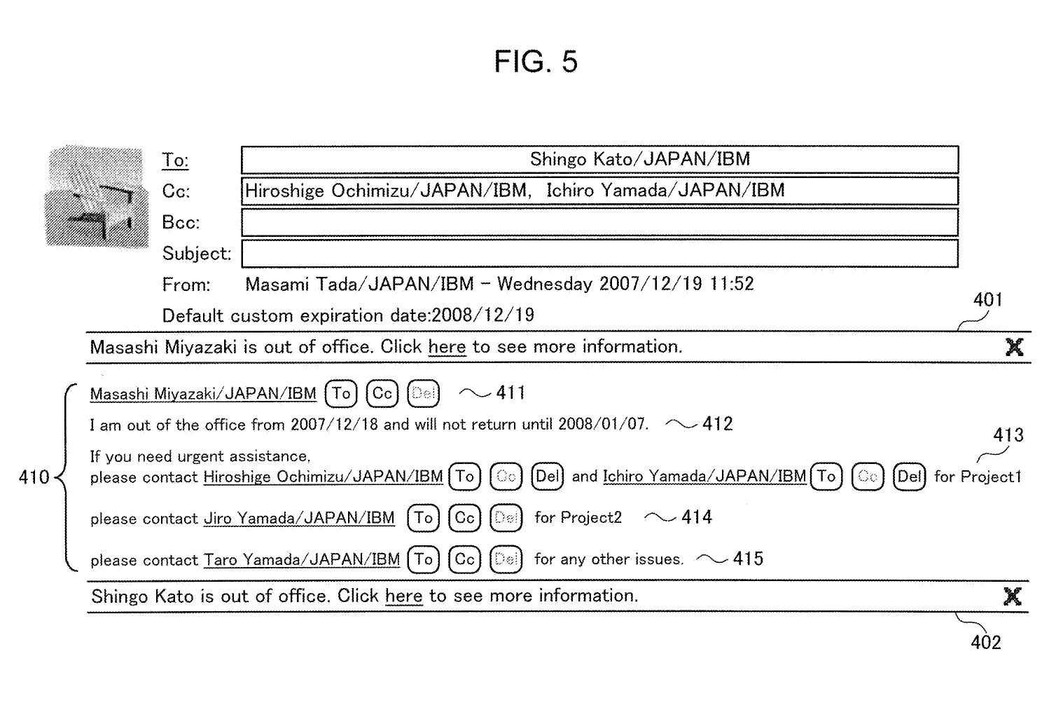

FIG. 5 shows a display screen example in which a destination address is reset.

FIG. 5 shows that the “Del” button in the primary-address information 411 is clicked so that “Masashi Miyazaki/JAPAN/IBM” that has been entered in the To-address entry field is deleted and that the “Cc” button on the right in the alternative address information 413 is clicked so that “Ichiro Yamada/JAPAN/IBM” is entered into the “Cc-address entry field”.

To disable the buttons, the “To” button may be grayed out when a corresponding mail address has already been entered in the To-address entry field, the “Cc” button may be grayed out when a corresponding mail address has already been entered in the Cc-address entry field, and the “Del” button may be grayed out when a corresponding mail address is not entered in both of the To-address entry field” and the Cc-address entry field. Specifically, the “To” button in FIG. 4 is grayed out, while the “To” button becomes enabled and the “Del” button is grayed out when the “Del” button is clicked in FIG. 5. The “Del” button on the right of the alternative address information 413 in FIG. 4 is grayed out, while the “Del” button becomes enabled and the “Cc” button is grayed out when the “Cc” button is clicked in FIG. 5.

Alternatively, the mail addresses in the primary-address information 411 and the alternative address information 413 to 415 may be colored according to the type of address, and when any button is clicked, its color may be changed. Suppose a To address is displayed in red, a Cc address is displayed in green, and other addresses are displayed in black. In this case, “Masashi Miyazaki/JAPAN/IBM” in the primary-address information 411 is displayed in red in FIG. 4. When the “Del” button is clicked in FIG. 5, it is changed to black. “Ichiro Yamada/JAPAN/IBM” in the alternative address information 413 of FIG. 4 is displayed in black in FIG. 4, while it is changed to green when the “Cc” button is clicked in FIG. 5.

Next, a second display screen example will be described in which “here” in the out-of-office message 401 of FIG. 3 is clicked so that detailed information is displayed.

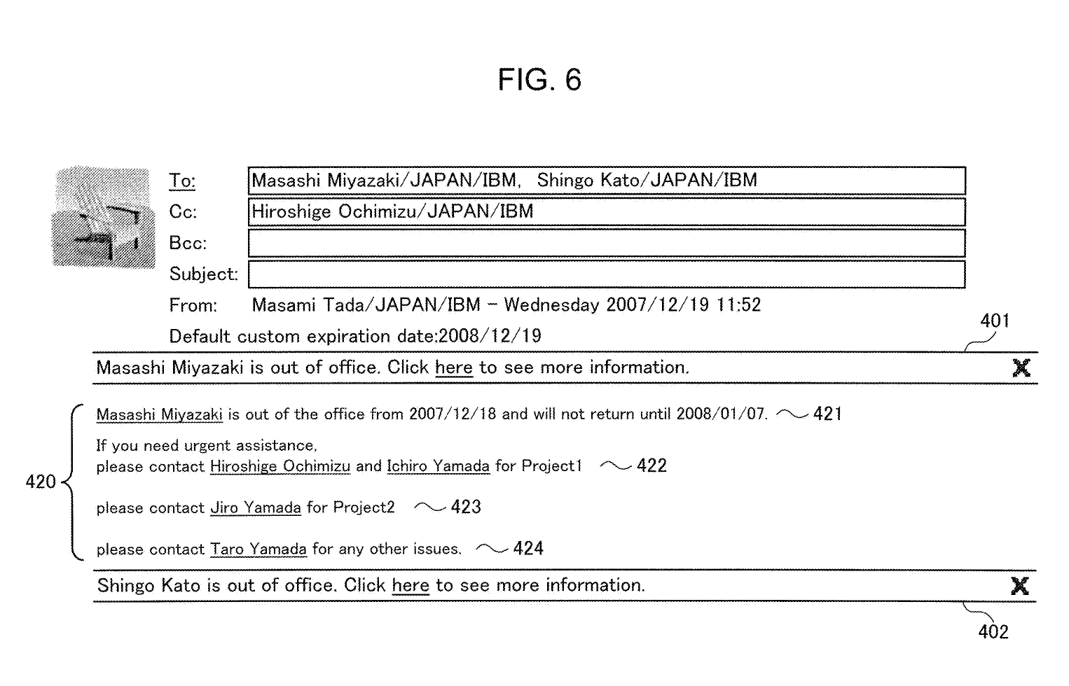

FIG. 6 shows the second display screen example.

FIG. 6 shows detailed information 420 of “Masashi Miyazaki/JAPAN/IBM” after “here” in the out-of-office message 401 is clicked.

The detailed information 420 includes primary-address information 421 for setting or deleting the primary address (including information of its out-of-office period) and alternative address information 422 to 424 for setting or deleting alternative addresses. Unlike the first display screen example, the primary-address information 421 and the alternative address information 422 to 424 each have not the “To” button, the “Cc” button, and the “Del” button. Instead, when a user name is clicked, its mail address can be added to or deleted from the To-address entry field and the Cc-address entry field. For example, when a user name is mouse-clicked and if a mail address corresponding to the user name has not been entered in the To-address entry field, the mail address is entered in the To-address entry field, while when the mail address corresponding to the user name has been entered in the To-address entry field, the mail address is deleted from the To-address entry field. For example, when a user name is clicked while the “Ctrl” key on the keyboard is being pushed and if a mail address corresponding to the user name has not been entered in the Cc-address entry field, the mail address is entered in the Cc-address entry field, while when the mail address corresponding to the user name has been entered in the Cc-address entry field, the mail address is deleted from the Cc-address entry field.

The outline of an operation when email sent with an alternative address being set or not being set is received by another client 20 will be described.

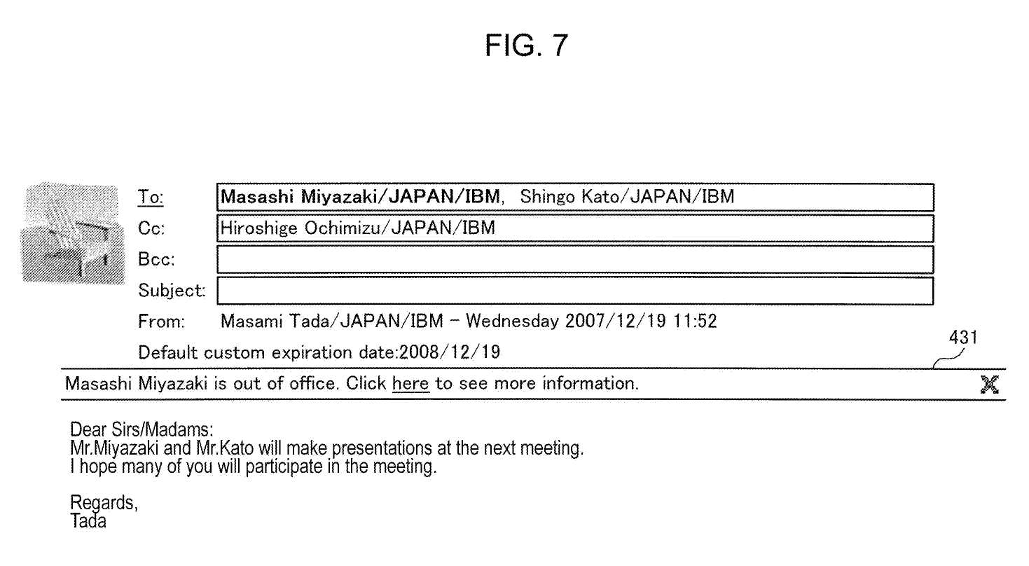

FIG. 7 shows a display screen example in which a user who is in the office reads received email.

Suppose “Masashi Miyazaki/JAPAN/IBM” is away. Then, “Masashi Miyazaki/JAPAN/IBM” in the To-address entry field is highlighted. For example, it may be colored or underlined. FIG. 7 shows it in boldface type. An out-of-office message 431 that “Masashi Miyazaki/JAPAN/IBM” is out of the office is displayed. This allows a user who received the email to be informed that he or she must take an action when the other users who received the same email are out of the office.

Also in this example, detailed information can be read when “here” in the out-of-office message 431 is clicked. However, no alternative address information is displayed and, for example, information of an out-of-office period is displayed, because the email has already been sent.

A computer system that executes the above operation will be described in detail.

The functional configuration of this computer system will be described.

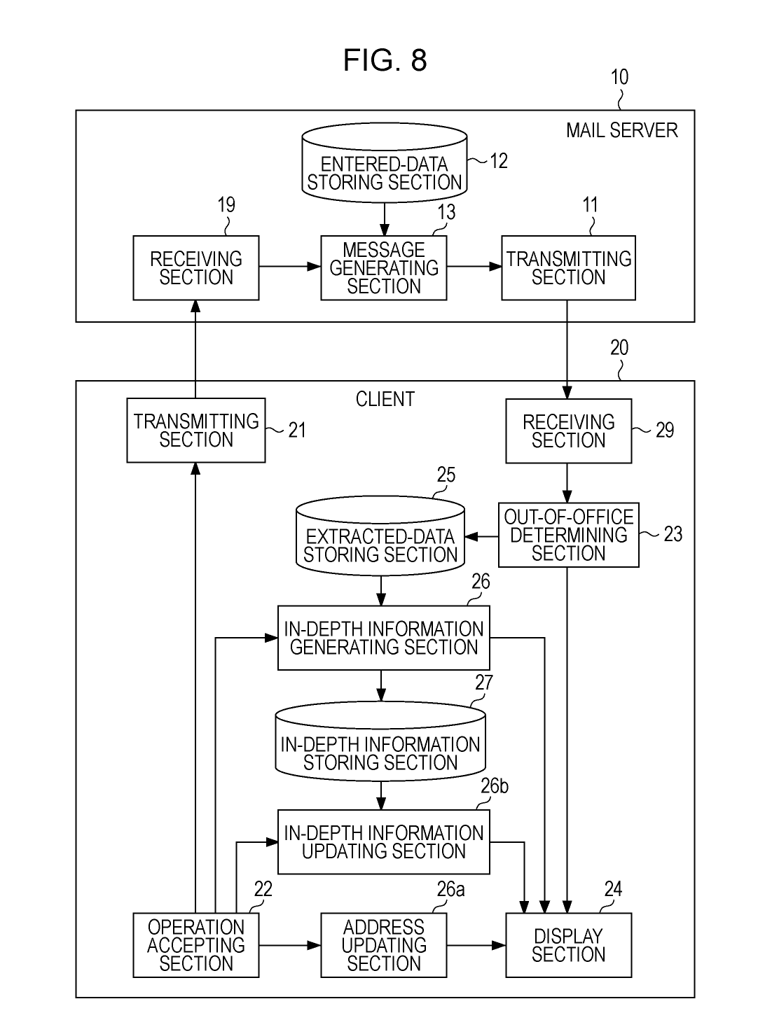

FIG. 8 is a block diagram showing an example of the functional configuration of the mail server 10 and the client 20.

First, the functional configuration of the mail server 10 will be described.

As shown in FIG. 8, the mail server 10 includes a transmitting section 11, an entered-data storing section 12, a message generating section 13, and a receiving section 19.

The transmitting section 11 sends email to the client 20. Particularly, in this embodiment, the transmitting section 11 sends a message having out-of-office information associated with a primary address to the client 20 in response to an inquiry from the client 20.

The entered-data storing section 12 stores out-of-office information entered by users as entered data. The out-of-office information is entered from, for example, the screen as shown in FIG. 2. The out-of-office information includes information of whether the user is away, the out-of-office period, and the mail address (alternative address) of a user who receives email during the out-of-office period. This embodiment uses the out-of-office information as an example of status information indicating that email cannot be read for a predetermined period.

The message generating section 13 extracts out-of-office information associated with the primary address for which inquired from the client 20, if present in the data stored in the entered-data storing section 12. The message generating section 13 generates a message having the extracted data.

The receiving section 19 receives from the client 20 the inquiry about whether the user corresponding to the primary address is away.

Secondly, the functional configuration of the client 20 will be described.

As shown in FIG. 8, the client 20 includes a transmitting section 21, an operation accepting section 22, an out-of-office determining section 23, a display section 24, an extracted-data storing section 25, a detailed information generating section 26, an address updating section 26a, a detailed information updating section 26b, a detailed information storing section 27, and a receiving section 29.

The transmitting section 21 transmits an email to the mail server 10. Particularly, this embodiment inquires of the mail server 10 whether a user corresponding to the entered primary address is away.

The operation accepting section 22 accepts the entry of the primary address into the address entry field, an operation for an object on an out-of-office message, and an operation for an object on detailed information. This embodiment is provided with the operation accepting section 22 as an example of a detecting section for detecting the destination address of an email.

The out-of-office determining section 23 determines whether the user corresponding to the entered primary address is away by analyzing whether the message sent from the mail server 10 has the extracted data. This embodiment is provided with the out-of-office determining section 23 as an example of a determining section for determining whether status information and an alternative address are stored.

The display section 24 displays an out-of-office message that the user corresponding to the input primary address is away and detailed information on the absence of the user.

The extracted-data storing section 25 stores data that the out-of-office determining section 23 extracted from the message.

The detailed information generating section 26 generates detailed information on the absence of the user corresponding to the input primary address using the extracted data stored in the extracted-data storing section 25 according to an operation for an object on the out-of-office message.

The detailed information storing section 27 stores the detailed information generated by the detailed information generating section 26.

The address updating section 26a enters an alternative address into the address entry field or deletes the primary address that has already been entered in the address entry field according to an operation for an object in the detailed information.

The detailed information updating section 26b updates the detailed information stored in the detailed information storing section 27 according to an operation for an object on the detailed information.

The receiving section 29 receives email. In this embodiment, the receiving section 29 receives a message having extracted data from the mail server 10.

The operation of this embodiment will be described. Processes before the transmission of an email include the resetting of a destination address from the screen shown in FIG. 5 and the resetting of a destination address from the screen shown in FIG. 6. This embodiment further includes the process after the reception of an email, as shown in FIG. 7. Hereinafter, the processes will be described as a first operation before email is sent, a second operation before the transmission of an email, and an operation after the reception of an email.

[First Operation Example Before Transmission of Email]

First, an operation for displaying an out-of-office message in response to the entry of the primary address into the address entry field, as shown in FIG. 3, will be described.

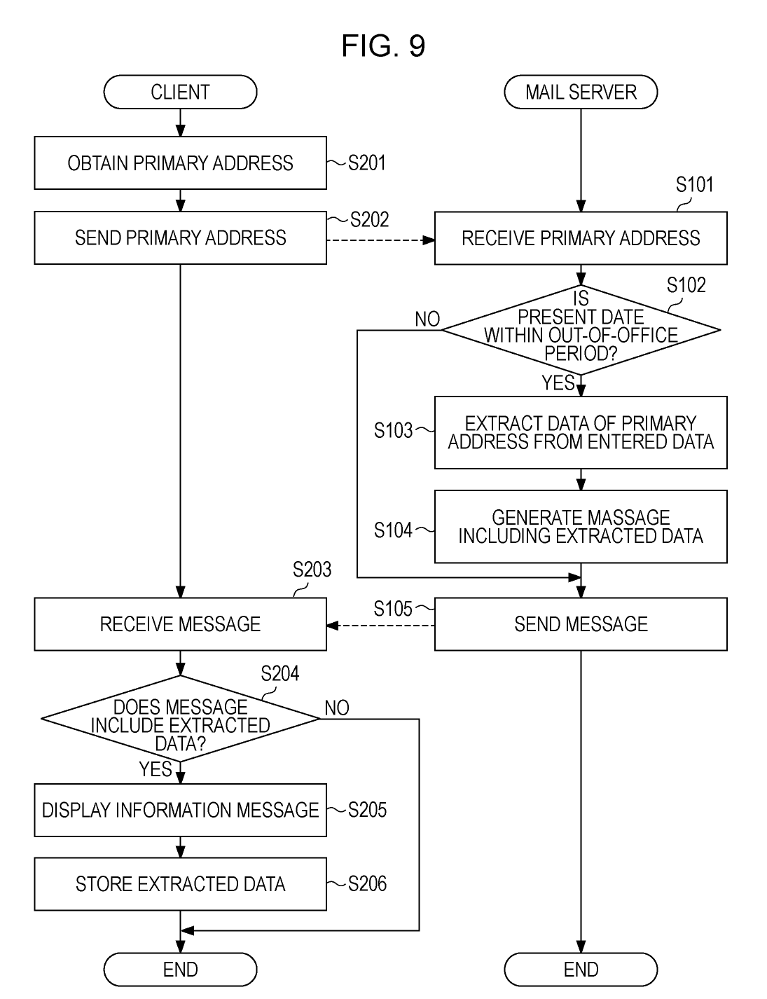

FIG. 9 is a flowchart of an example of the operation of the client 20 and the mail server 10 at that time.

When a primary address is entered into the To-address entry field or the Cc-address entry filed, the operation accepting section 22 of the client 20 obtains the entered primary address, and passes it to the transmitting section 21 (step S201). Preferably, when a delimiter, such as a comma or a semicolon, is entered during the entry of a destination address into the To-address entry field or the Cc-address entry field, a character string before the delimiter is recognized as a primary address. Alternatively, when the focus is shifted from one address entry field to another address entry field, a character string entered in the address entry field before the shift of focus may be recognized as a primary address.

The transmitting section 21 transmits the passed primary address to the mail server 10 (step S202).

The receiving section 19 of the mail server 10 receives the primary address and passes it to the message generating section 13 (step S101). Then, the message generating section 13 reads the out-off-office period of the user corresponding to the passed primary address from the entered-data storing section 12, and determines whether the present date is included in this an out-of-office period (step S102).

If it is determined that the present date is included in the out-of-office period, out-of-office information corresponding to the primary address is extracted as extracted data from the entered data stored in the entered-data storing section 12 (step S103). The message generating section 13 generates a message having the extracted data and passes the message to the transmitting section 11 (step S104). Thereafter, the transmitting section 11 sends the passed message to the client 20 (step S105).

In contrast, if it is determined that the present data is not including in the out-of-office period, no extracted data is written to the message, and the transmitting section 11 sends the reply message having no extracted data to the client 20 (step S105).

When the mail server 10 sends the reply message, the receiving section 29 of the client 20 receives the message and passes it to the out-of-office determining section 23 (step S203). The out-of-office determining section 23 determines whether the message has the extracted data (step S204).

As a result, if it is determined that the message has the extracted data, the out-of-office determining section 23 generates an out-of-office message that the user corresponding to the input primary address is away and passes it to the display section 24. The display section 24 displays the out-of-office message (step S205). The extracted data is taken and stored in the extracted-data storing section 25 so that detailed information can be displayed when a specific portion in the out-of-office message is clicked (step S206).

In contrast, if it is determined that the message has no extracted data, the out-of-office determining section 23 terminates the process without giving an instruction to display the out-of-office message or store the extracted data.

An operation to display detailed information by clicking a specific portion of the out-of-office message, as shown in FIG. 4, will be described.

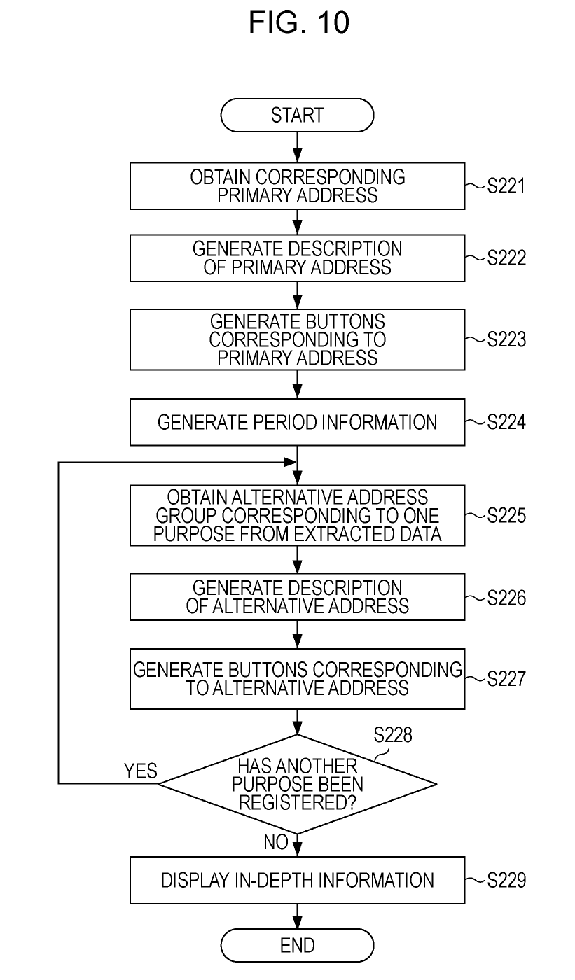

FIG. 10 is a flowchart of an example of the operation of the client 20 at that time.

When a specific portion (“here” in FIG. 4) in the out-of-office message is mouse-clicked, the operation accepting section 22 of the client 20 obtains the mail address (the primary address) of the user corresponding to the specific portion, and passes it to the detailed information generating section 26 (step S221). In the example of FIG. 4, when “here” in the out-of-office message 401 is clicked on, the operation accepting section 22 obtains the primary address “Masashi Miyazaki/JAPAN/IBM”.

The detailed information generating section 26 first generates a description on the primary address from the primary-address information in the detailed information (step S222). In the example of FIG. 4, the detailed information generating section 26 generates a description “Masashi Miyazaki/JAPAN/IBM”. The detailed information generating section 26 also generates “To button”, “Cc button”, and “Del button” corresponding to the primary address (step S223). Since the primary address here is a destination address entered in the “To-address entry field”, the “To button” is grayed out so as not to be selected. In generating these buttons, programs (the address updating section 26a and the detailed information updating section 26b) associated with these buttons should also be generated so as to be operated when the buttons are clicked.

The detailed information generating section 26 generates a description (period information) about the out-of-office period stored for this user (step S224). Specifically, the detailed information generating section 26 searches the extracted-data storing section 25 for the out-of-office period using the primary address as the key, and generates the description. In the example of FIG. 4, the detailed information generating section 26 extracts an out-of-office period “2007/12/18-2008/01/07”, and generates period information “I am out of the office from 2007/12/18 and will not return until 2008/01/07”.

The detailed information generating section 26 then obtains an alternative address group corresponding to one purpose (step S225). Specifically, the detailed information generating section 26 searches the extracted-data storing section 25 using the primary address as the key, and extracts a group of alternative addresses and their purposes. In the example of FIG. 4, the detailed information generating section 26 extracts a group of alternative addresses “Hiroshige Ochimizu/JAPAN/IBM” and “Ichiro Yamada/JAPAN/IBM” and the purpose “Project1”.

The detailed information generating section 26 then generates the description of the alternative addresses that substitute for the primary address of the email sent for this purpose (step S226). In the example of FIG. 4, the detailed information generating section 26 generates a description “please contact Hiroshige Ochimizu/JAPAN/IBM and Ichiro Yamada/JAPAN/IBM for Project1”. The detailed information generating section 26 also generates “To button”, “Cc button”, and “Del button” corresponding to the primary address included in this description (step S227). The “To button” corresponding to the alternative address that has already been entered in the To-address entry field is grayed out so as not to be selected. The “Cc button” corresponding to the alternative address that has already been entered in the Cc-address entry field is grayed out so as not to be selected. The “Del button” corresponding to the alternative address that has not been entered in any of the address entry fields is grayed out so as not to be selected. In generating these buttons, programs (the address updating section 26a and the detailed information updating section 26b) associated with these buttons should also be generated so as to be operated when the buttons are clicked.

Thereafter, the detailed information generating section 26 determines whether another purpose of the email is registered (step S228). If another purpose is registered, the process of steps S225 to 227 is repeated. In the example of FIG. 4, the description “please contact Jiro Yamada/JAPAN/IBM for Project2” and buttons corresponding to the alternative address in this description, the description “please contact Taro Yamada/JAPAN/IBM for any other issues.” and buttons corresponding to the alternative address in this description are also generated. If no other purpose is registered, the generation of detailed information is terminated, and the generated detailed information is passed to the display section 24.

The display section 24 displays the detailed information sent from the detailed information generating section 26 (step S229).

An operation for resetting a destination address by clicking a button in the detailed information, as shown in FIG. 5, will be described. Since there are “To button”, “Cc button”, and “Del button” in the detailed information, as described above, the operations when those buttons are clicked will be described separately.

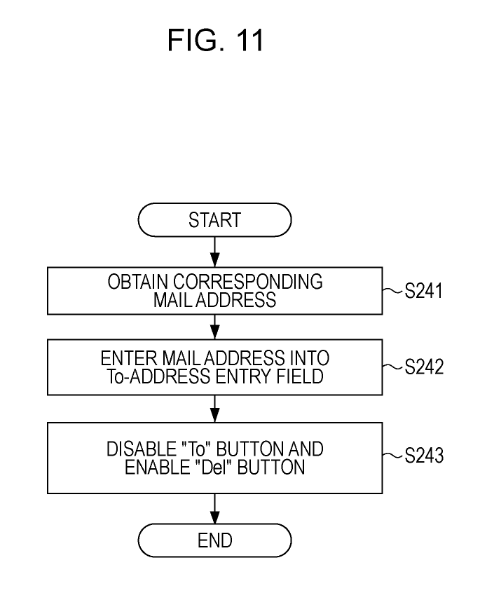

FIG. 11 is a flowchart of an example of the operation of the client 20 when “To” button is clicked.

When “To” button is clicked, the operation accepting section 22 of the client 20 obtains a mail address corresponding to the clicked “To” button, and passes it to the address updating section 26a and the detailed information updating section 26b (step S241).

Then, the address updating section 26a instructs the display section 24 to display the passed mail address in the To-address entry field. The display section 24 displays the entered mail address in the To-address entry field (step S242).

The detailed information updating section 26b updates the detailed information stored in the detailed information storing section 27 so that the clicked “To” button cannot be selected and the corresponding “Del” button can be selected, and passes the updated detailed information to the display section 24. The display section 24 displays the passed detailed information (step S243).

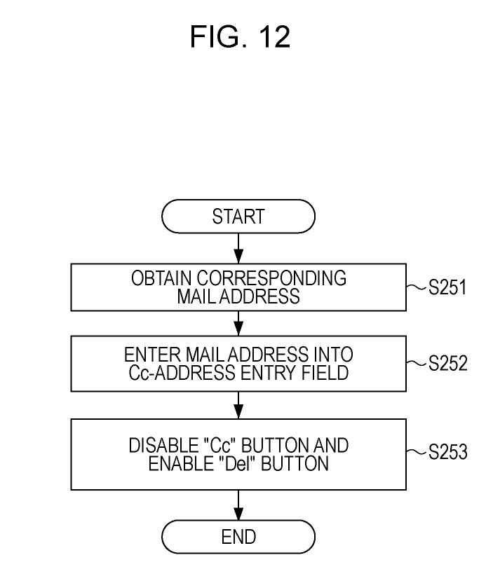

FIG. 12 is a flowchart of an example of the operation of the client 20 when “Cc” button is clicked.

When “Cc” button is clicked, the operation accepting section 22 of the client 20 obtains a mail address corresponding to the clicked “Cc” button, and passes it to the address updating section 26a and the detailed information updating section 26b (step S251).

The address updating section 26a instructs the display section 24 to display the passed mail address in the Cc-address entry field. The display section 24 displays the entered mail address in the Cc-address entry field (step S252).

The detailed information updating section 26b updates the detailed information stored in the detailed information storing section 27 so that the clicked “Cc” button cannot be selected and the corresponding “Del” button can be selected, and passes the updated detailed information to the display section 24. The display section 24 displays the passed detailed information (step S253).

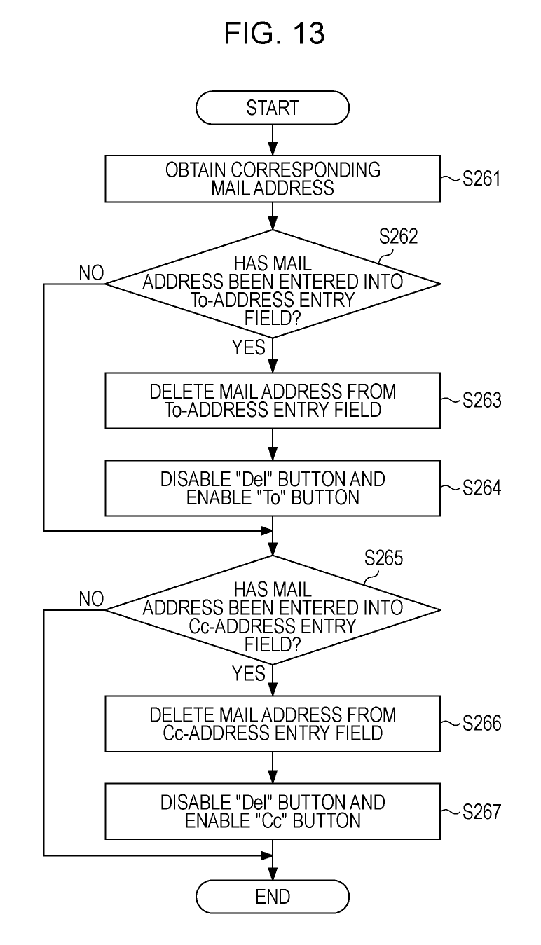

FIG. 13 is a flowchart of an example of the operation of the client 20 when “Del” button is clicked.

When “Del” button is clicked, the operation accepting section 22 of the client 20 obtains a mail address corresponding to the clicked “Del” button, and passes it to the address updating section 26a and the detailed information updating section 26b (step S261).

Then, the address updating section 26a determines whether the passed mail address has already been entered in the To-address entry field with reference to the current display state stored in a memory (not shown) (step S262). If the mail address has already been entered in the To-address entry field, the address updating section 26a instructs the display section 24 to delete the passed mail address from the To-address entry field. The display section 24 displays the information, with the mail address deleted from the To-address entry field (step S263). The information that the passed mail address has been entered in the To-address entry field is also provided to the detailed information updating section 26b. In this case, the detailed information updating section 26b updates the detailed information stored in the detailed information storing section 27 so that the clicked “Del” button cannot be selected and the corresponding “To” button can be selected, and passes the updated detailed information to the display section 24. The display section 24 displays the passed detailed information (step S264).

The address updating section 26a determines whether the passed mail address has already been entered in the Cc-address entry field with reference to the current display state stored in the memory (not shown) (step S265). If the mail address has already been entered in the Cc-address entry field, the address updating section 26a instructs the display section 24 to delete the passed mail address from the Cc-address entry field. The display section 24 displays the information, with the mail address deleted from the Cc-address entry field (step S266). The information that the passed mail address has been entered in the Cc-address entry field is also provided to the detailed information updating section 26b. In this case, the detailed information updating section 26b updates the detailed information stored in the detailed information storing section 27 so that the clicked “Del” button cannot be selected and the corresponding “Cc” button can be selected, and passes the updated detailed information to the display section 24. The display section 24 displays the passed detailed information (step S267).

[Second Operation Example Before Transmission of Email]

An operation for displaying an out-of-office message according to the entry of the primary address to the address entry field as shown in FIG. 3, is omitted because it is the same as that of FIG. 9.

An operation for displaying detailed information by clicking a specific portion in the out-of-office message, as shown in FIG. 6, is substantially the same as that of FIG. 10. However, no button is displayed in this operation example. Accordingly, steps S223 and 227 are not executed and the program for resetting the mail address is associated with the description of the user name in steps S222 and 226.

An operation for resetting a destination address by clicking a user name in detailed information will be described.

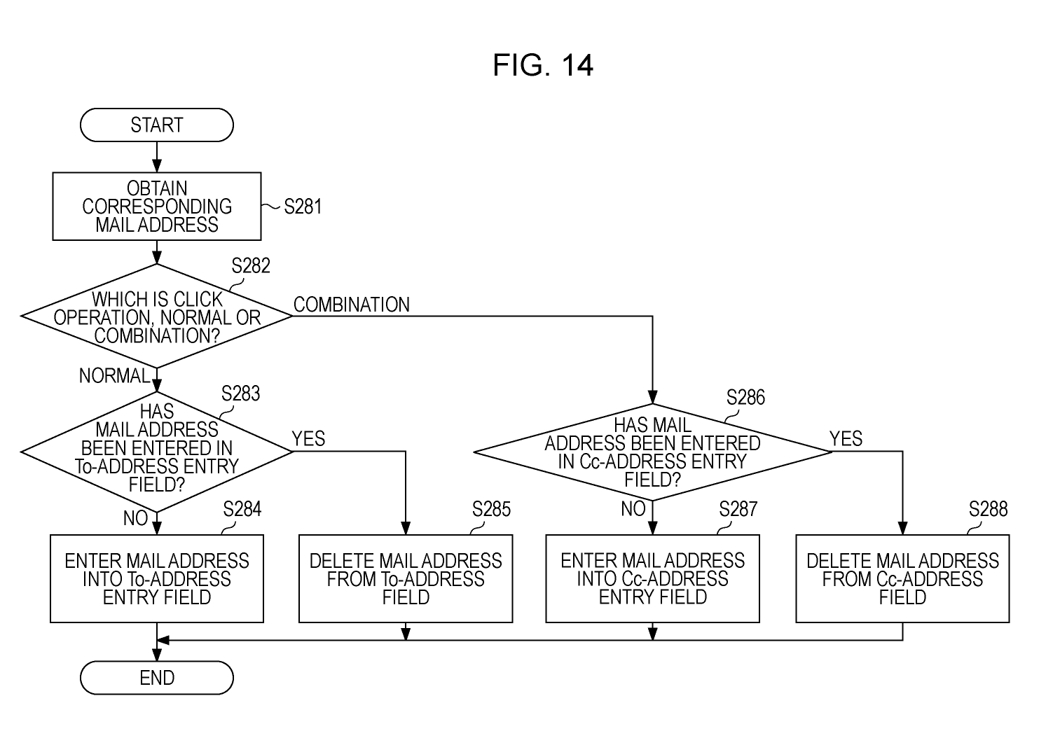

FIG. 14 is a flowchart of an example of the operation of the client 20 at that time.

When a user name description is clicked, the operation accepting section 22 of the client 20 obtains a mail address corresponding to the user name (step S281). The detailed information displayed includes the user name but no mail address. It is therefore preferable to have correlation information of the user name and the mail address in a no displayed portion of the detailed information so that the mail address can be obtained from this correlation information. The mail address is passed to the address updating section 26a together with information about whether the click operation is accompanied by key pressing (hereinafter, referred to as “a combination click”) or not (hereinafter, referred to as “a normal click”).

Then, the address updating section 26a determines whether the click operation is the normal click or the combination click (step S282).

If it is determined that the click operation is a normal click, then the address updating section 26a determines whether the passed mail address has already been entered in the To-address entry field with reference to the current display state stored in the memory (not shown) (step S283). If the mail address has not been entered in the To-address entry field, the address updating section 26a instructs the display section 24 to display the passed mail address in the To-address entry field. The display section 24 displays the mail address in the To-address entry field (step S284). If the mail address has been entered in the To-address entry field, the address updating section 26a instructs the display section 24 to delete the passed mail address from the To-address entry field. The display section 24 displays the information, with the mail address deleted from the To-address entry field (step S285).

In contrast, If it is determined that the click operation is a combination click, then the address updating section 26a determines whether the passed mail address has already been entered in the Cc-address entry field with reference to the current display state stored in the memory (not shown) (step S286). If the mail address has not been entered in the Cc-address entry field, the address updating section 26a instructs the display section 24 to display the passed mail address in the Cc-address entry field. The display section 24 displays the mail address in the Cc-address entry field (step S287). If the mail address has been entered in the Cc-address entry field, the address updating section 26a instructs the display section 24 to delete the passed mail address from the Cc-address entry field. The display section 24 displays the information, with the mail address deleted from the Cc-address entry field (step S288).

In this operation example, which of the To-address entry field and the Cc-address entry field the mail address is to be input to or deleted from is determined from whether the click operation is the simple mouse click operation or the mouse click operation with a key down operation. The present invention is not limited to that. The present invention may employ any two operating methods that are determined for the To-address entry field and the Cc-address entry field, respectively.

[Operation Example after Reception of Email]

This operation example is executed when a user who received email opens the message.

An operation for displaying an out-of-office message when the message is opened, shown in FIG. 7, is substantially the same as that shown in FIG. 9. In steps S201, S202, S101, and S103 of FIG. 9, the primary address entered from the screen is processed, while in this operation example, the mail address that has already been entered in the address entry field when email is sent is processed. However, the user who is reading the mail message may be excluded from the object to be processed because obviously not being away. Alternatively, the sender may send the email including the out-of-office message, and only the mail address corresponding to the out-of-office message may be processed.

An operation for displaying detailed information by clicking a specific portion of an out-of-office message is substantially the same as that in FIG. 10. However, since no primary address information and no alternative address information is displayed in this example, steps S222, S223, and S225 to 228 are not executed.

The present invention has been described in detail in its preferred form.

The foregoing embodiment assumes that the destination user cannot read email for a specified period because of being away. This is merely an example; various examples according to the circumstances of the recipient of an email are possible, such as a state in which the destination user cannot read email because of being busy not because of being away.

The state in which email cannot be read for a specified period is not limited to a state in which all email sent to one mail address cannot be read for a specified period, but may include a state in which only email sent from a specific sending end cannot be read for a specified period. In that sense, the state in which email cannot be read for a specified period is an example of a state in which email sent to one mail address cannot be read for a specified period.

As described above, this embodiment is configured to send an inquiry whether a user corresponding to the destination address of an email is away when the destination address is entered into an address entry field and display the result. This allows the sender to be informed early about whether the destination user is away and early select alternative means.

This embodiment is configured to display the candidates of an alternative recipient of an email when the destination user is away. This allows the sender to select an alternative recipient. For example, it is important in sending email including secret information or personal information to select the recipient of the email not automatically but by the sender.

This embodiment is configured to display the mail addresses of the candidates of an alternative recipient of an email. This saves the sender's time required for looking up the mail address in the address book.

This embodiment is configured to set or delete a To address or a Cc address according to the operation of clicking a button or the like. This eliminates the need for the operation of, for example, copying and pasting a mail address.

This embodiment is configured to provide information on the circumstances of the other recipients also when email is received. This allows a user who reads the email to determine whether to take an action.

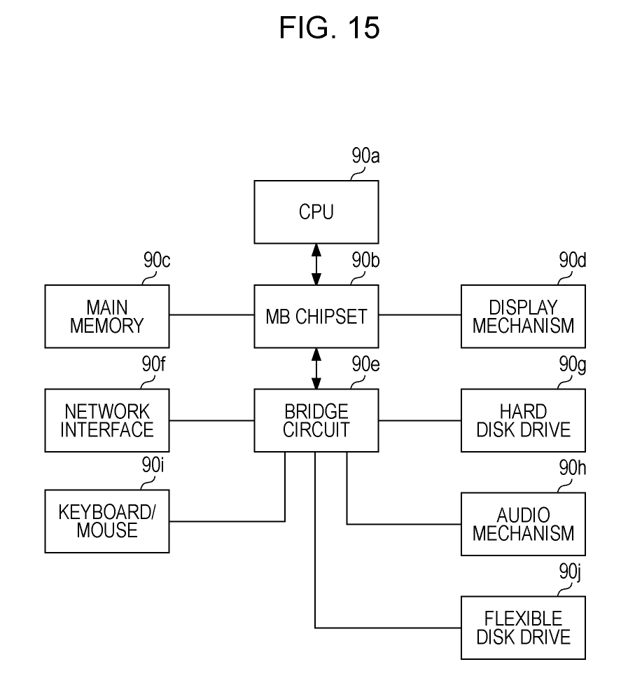

Lastly, the hardware configuration of a computer suitable for this embodiment will be described. FIG. 15 is a diagram showing an example of such a hardware configuration. As shown in FIG. 15, the computer includes a central processing unit (CPU) 90a, a main memory 90c connected to the CPU 90a through a motherboard (MB) chipset 90b, and a display mechanism 90d connected to the CPU 90a also through the MB chipset 90b. The MB chipset 90b is connected to a network interface 90f, a hard disk drive (HDD) 90g, an audio mechanism 90h, a keyboard/mouse 90i, and a flexible disk drive 90j through a bridge circuit 90e.

Referring to FIG. 15, the components are connected together with buses. For example, the CPU 90a and the MB chipset 90b, and the MB chipset 90b and the main memory 90c are each connected with a CPU bus. The MB chipset 90b and the display mechanism 90d may be connected with an accelerated graphic port (AGP). However, if the display mechanism 90d includes a peripheral components interconnect (PCI) Express video card, the MB chipset 90b and the video card are connected with a PCI Express (PCIe) bus. To connect with the bridge circuit 90e, the network interface 90f may use, for example, PCI Express. For the hard disk drive 90g, serial AT attachment (ATA), parallel ATA, or PCI may be used. For the keyboard/mouse 90i and the flexible disk drive 90j, a universal serial bus (USB) may be used.

The present invention may be implemented either via hardware or software, or alternatively, via both of hardware and software. The present invention may be implemented as a computer, a data processing system, and a computer program. The computer program may be stored in a computer-readable medium for provision. Examples of the medium include an electronic, magnetic, optical, electromagnetic, infrared, or semiconductor system (unit or device) or transmission media. Examples of the computer-readable medium include a semiconductor memory, a solid-state storage unit, magnetic tape, a removable computer diskette, a random access memory (RAM), a read-only memory (ROM), a rigid magnetic disk, and an optical disk. Examples of the optical disk at the present time include a compact disc read-only memory (CD-ROM), a compact disc read/write (CD-R/W), and DVD.

Although the present invention has been described in its preferred form, it is to be understood that the technical scope of the present invention is not limited to that described in the embodiment. It will be obvious to those skilled in the art that various changes or modifications can be made without departing from the spirit and scope of the present invention.

1. A computer system that supports setting of a destination address of an email, the system comprising:
a detecting section of the computer system coupled to a mail server that detects a destination address of an email as a primary address in response to a user's input; and
a display section of the computer system that displays a message before sending the email to the mail server when receiving status information, from a recipient of the email, indicating that the email has not been read by the recipient for a predetermined period.

2. The computer system according to claim 1, wherein the display section displays the message including a specific object, and displays information on the specified period according to a user operation performed on the specific object.

3. The computer system according to claim 1, wherein when an alternative address substituting for the primary address has been registered in addition to the status information, the display section further displays the alternative address.

4. The computer system according to claim 3, wherein when the alternative address has been registered in association with a specific category, the display section displays the alternative address information that further indicates that the alternative address is substituting for the primary address for email in the specific category.

5. The computer system according to claim 3, wherein the display section further displays an entry field for the destination address of the email, and when a user operation on an object corresponding to the entry field and the alternative address is performed, the display section displays the entry field, with the alternative address entered.

6. The computer system according to claim 3, wherein the display section further displays an entry field for the destination address of the email, and when a user operation on an object corresponding to the alternative address is performed by a predetermined method corresponding to the entry field, the display section displays the entry field, with the alternative address entered.

7. The computer system according to claim 1, wherein the display section further displays an entry field for the destination address of the email, and when a user operation on an object corresponding to the primary address is performed, the display section displays the entry field, with the primary address entered in the entry field being deleted.

8. The computer system according to claim 1, further comprising
a receiving section in the mail server that receives a second email from another computer system apparatus, wherein
the detecting section of the computer system detects the destination address of the second email received by the receiving section; and
when a second recipient of the second email has set status information indicating that the second mail is not read for a specified period, the display section notifies the another apparatus of the status.

9. A computer system that supports setting of a destination address of an email, the system comprising:
a detecting section of the computer system coupled to a mail server that detects the destination address of the email as a primary address according to an operation of a user for entering the destination address;
a determining section of the computer system that determines whether the primary address detected by the detecting section has status information and an alternative address substituting for the primary address, the status information indicating that the email is not read for a specified period; and
a display section of the computer system that displays an entry field for the destination address of the email, and when the determining section determines that the status information and the alternative address have been registered, the display section displays alternative address information including the information of the alternative address and an object corresponding to the entry field and the alternative address, wherein when a user operation on the object is performed, the display section displays the entry field, with the alternative address entered.

10. A method for supporting the setting of the destination of an email, the method comprising the steps of:
detecting in a client of a computer system the destination address of the email as a primary address according to an operation of a user for entering the destination address; and
when the primary address detected by the detecting section has status information indicating the status of the email, displaying in the computer system a message indicating that the email has not been read for a specified period.

11. A program product for a computer that supports the setting of the destination of an email, the program product comprising:
computer usable program code for detecting the destination address of the email as a primary address according to an operation of a user for entering the destination address; and
computer usable program code for displaying, when the primary address detected by the detecting section has status information indicating the status of the email, a message indicating that the email has not been for a specified period.
